(19) United States
(12) Patent Application Publication
(10) Pub. No.: US 2024/0405645 A1
(43) Pub. Date: Dec. 5, 2024

(54) ELECTRIC POWER UNIT

(71) Applicant: NIDEC CORPORATION, Kyoto (JP)

(72) Inventors: Hiroki AKAISHI, Kyoto (JP); Kazuyuki YAMAMOTO, Kyoto (JP); Daisuke OGASAWARA, Kyoto (JP)

(21) Appl. No.: 18/696,860

(22) PCT Filed: Jun. 10, 2022
(86) PCT No.: PCT/JP2022/023536

§ 371 Date: Mar. 28, 2024

(30) Foreign Application Priority Data
Sep. 29, 2021 (JP) 2021-159534

(51) Int. Cl. H02K 11/33; H02K 5/18; H02K 9/19

(52) U.S. Cl. CPC H02K 11/33; H02K 9/19; H02K 5/18

(57) ABSTRACT

An electric power unit accommodates an electric motor in a first portion of a housing, and an inverter in a second portion of the housing. An upper surface opening portion of the second portion is covered with an inverter cover having a flat plate shape. A first region, a second region, and a third region sandwiched between the first region and the second region are formed on an upper surface of the inverter cover. A first connection portion is arranged in the first region. Second connection portions are arranged in the second region. A plurality of ribs are arranged in parallel in the third region. The first rib having one longitudinal end portion connected to the first connection portion and the second rib connected to the second connection portions are arranged in a direction in which the first rib and the second rib are arranged in parallel.

### CROSS-REFERENCE TO RELATED APPLICATIONS

This is the U.S. national stage of application No. PCT/JP2022/023536, filed on Jun. 10, 2022, and priority under 35 U.S.C. § 119 (a) and 35 U.S.C. § 365 (b) is claimed from Japanese Patent Application No. 2021-159534, filed on Sep. 29, 2021.

### TECHNICAL FIELD

The present invention relates to an electric power unit using an electric motor as a driving source.

### BACKGROUND ART

In recent years, an electric vehicle (EV) that uses an electric motor as a driving source has been actively developed instead of a vehicle that uses an engine discharging exhaust gas as a driving source. Further, the electric vehicle is equipped with a power unit configured by integrally incorporating, in a housing, the electric motor (an AC motor) that is the driving source, an inverter that converts DC current from a DC power supply, such as a battery, into AC current and supplies the AC current to the electric motor, a speed reduction mechanism that decelerates (increases a torque for) rotation of the electric motor, a differential mechanism (differentiating mechanism) that differentiates rotation output from the speed reduction mechanism to left and right output shafts, and the like.

Uncomfortable vibration and noise are imparted to an occupant in a case where vibration of a power unit incorporating an electric motor, which is a vibrating source, is large, and thus, it is desired to reduce the vibration and noise of the power unit to be low.

As a method of reducing vibration of an electric motor to be low, there are known a method of changing a distance of an air gap at each tooth tip of a stator core by a magnetic structure of the electric motor to offset a specific electromagnetic vibrating force component generated in the stator core (see Patent Literature 1), a method of reducing vibration of a specific order by offsetting electromagnetic force generated in a stator core by current control (see Patent Literature 2), and the like.

There is also known a method of enhancing rigidity of a motor housing that accommodates an electric motor to reduce vibration and noise of the motor housing to be low. For example, Patent Literature 3 proposes a configuration in which the number of reinforcing ribs of a flange of a motor housing is set to a number that is not a divisor of the number of slots of a stator, is not a multiple of the number of slots, is not a divisor of the number of poles of a rotor, and is not a multiple of the number of poles.

Further, Patent Literature 4 proposes a configuration in which a rubber mount supporting a power plant including an engine on a vehicle body frame is joined to the power plant via an engine-side mount bracket, and movement of the rubber mount is restrained by a restraint device including an electromagnet joined to the engine-side mount bracket and a vehicle-frame-side mount bracket via a prop to increase spring rigidity of the rubber mount, so that vibration of the power plant generated when the engine is started and stopped is reduced to be low.

### CITATIONS LIST

### Patent Literature

Patent Literature 1: JP 2007-166710 A
Patent Literature 2: JP 2005-057935 A
Patent Literature 3: JP 2004-096845 A
Patent Literature 4: JP 2013-023136 A

### SUMMARY OF INVENTION

### Technical Problems

In an electric power unit including an inverter, the inverter is accommodated in an inverter accommodating portion formed integrally with a housing, and an opening portion of the inverter accommodating portion is closed by an inverter cover that is detachable. Here, the inverter cover is a relatively thin rectangular flat plate-shaped member, and has a large sound area. Therefore, there is a problem that the inverter cover resonates due to vibration generated by driving of an electric motor and becomes a sound source, and a noise level radiated from the inverter cover becomes large.

In order to solve the above problem, it is conceivable to increase rigidity of the inverter cover by forming a reinforcing rib on a surface of the inverter cover. However, in a case where the inverter cover is arranged substantially horizontally on the upper side of a vehicle, when a reinforcing rib is formed on an upper surface of the inverter cover, there is a problem that when water enters an engine room due to precipitation or the like, the water accumulates on the upper surface of the inverter cover and various troubles occur.

The present invention has been made in view of the above problem, and an object of the present invention is to provide an electric power unit in which rigidity of an inverter cover is increased so that a noise level due to resonance of the inverter cover can be reduced to be low without causing a problem of accumulation of water.

### Solutions to Problems

In order to achieve the above object, the present invention relates to an electric power unit accommodating an electric motor in a motor accommodating portion formed in a housing, and accommodating an inverter in an inverter accommodating portion formed in an upper portion of the housing, and having an upper surface opening portion of the inverter accommodating portion covered with an inverter cover having a flat plate shape. A first region, a second region, and a third region sandwiched between the first region and the second region are formed on an upper surface of the inverter cover, and a first connection portion is arranged in the first region, a second connection portion is arranged in the second region, a plurality of ribs are arranged in parallel in the third region, and a first rib having one longitudinal end portion connected to the first connection portion and a second rib connected to the second connection portion are arranged in a direction in which the first rib and the second rib are arranged in parallel.

### Advantageous Effects of Invention

According to the present invention, since rigidity of an inverter cover is enhanced by a plurality of ribs, membrane vibration due to resonance of the inverter cover is reduced to be low, and a noise level generated with the membrane vibration is also reduced to be low.

Further, another longitudinal end portion of the first rib and the second rib arranged in a direction in which the ribs are arranged in parallel is not connected to the second connection portion or the first connection portion (that is, the second connection portion for the first rib, and the first connection portion for the second rib), and a gap is formed between the another longitudinal end portion (free end) and the second connection portion and the first connection portion. For this reason, a flow path having a labyrinth structure is formed by the first rib and the second rib on an upper surface of the inverter cover, and in a case where water enters an engine room due to precipitation or the like, the water flows along the flow path and is discharged from both end portions (opening portions) of the flow path to the outside of the inverter cover. As a result, water is not accumulated on an upper surface of the inverter cover, and occurrence of various troubles associated with accumulation of water is prevented.

### BRIEF DESCRIPTION OF DRAWINGS

FIG. 1 is a longitudinal sectional view schematically illustrating the entire configuration of an electric power unit according to the present invention as viewed from the rear side of a vehicle.

FIG. 2 is a perspective view of the electric power unit according to the present invention as viewed from the obliquely right rear side.

FIG. 3 is a right side view of the electric power unit according to the present invention.

FIG. 4 is a perspective view of an inverter cover according to a first embodiment.

FIG. 5 is a plan view of the inverter cover according to the first embodiment.

FIG. 6 is a diagram illustrating a relationship between a motor rotational speed and a noise level of the electric power unit according to the present invention in comparison with that of a conventional electric power unit.

FIG. 7 is a perspective view of the inverter cover according to a second embodiment.

FIG. 8 is a plan view of the inverter cover according to the second embodiment.

### DESCRIPTION OF EMBODIMENTS

Hereinafter, an embodiment of the present invention will be described with reference to the drawings.

### [Basic Configuration and Operation of Electric Power Unit]

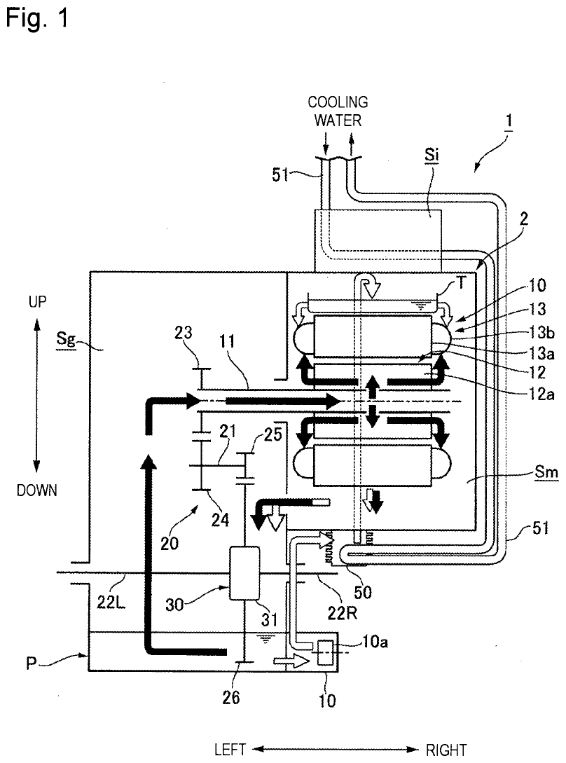

FIG. 1 is a longitudinal sectional view schematically illustrating the entire configuration of an electric power unit according to the present invention as viewed from the rear side of a vehicle, and an electric power unit 1 illustrated in the diagram is mounted on an electric vehicle (EV). In FIG. 1, arrow directions are defined as an “up-down” direction and a “left-right” direction (vehicle width direction) as illustrated.

In the electric power unit 1 according to the present embodiment, an electric motor 10, which is a driving source, is accommodated in a motor accommodating portion (motor chamber) Sm formed in the right half inside a housing 2 produced by aluminum die-casting, and a speed reduction mechanism 20 and a differential mechanism (differentiating mechanism) 30 are accommodated in a gear accommodating portion (gear chamber) Sg formed in the left half inside the housing 2. Further, an inverter (not illustrated) is accommodated in an inverter accommodating portion Si formed in an upper portion of the housing 2. Note that the inverter is configured to convert DC current from a battery, which is a DC power supply and is not illustrated, into AC current and supply the AC current to the electric motor 10, and include a control element such as an IGBT.

Here, the electric motor 10 is a three-phase AC motor, and includes a rotor 12, which rotates together with a hollow shaft (motor shaft) 11 passing through the center of the rotor 12, and a cylindrical stator 13 fixed around the rotor 12. Here, the shaft 11 is horizontally arranged along the left-right direction (vehicle width direction) in FIG. 1, and the rotor 12 fixed to an outer periphery of the shaft 11 includes a rotor core 12a and a permanent magnet (not illustrated) embedded in the rotor core 12a. Further, the stator 13 includes a stator core 13a and a coil 13b, and the coil 13b is electrically connected to the inverter.

Inside the gear accommodating portion Sg, a counter shaft 21 and left and right output shafts 22L and 22R are arranged in parallel to the shaft 11. The speed reduction mechanism 20 includes: a first gear 23 connected to an outer periphery of a left end portion facing the inside of the gear accommodating portion Sg of the shaft 11; a second gear 24 and a third gear 25 having different diameters and connected to the counter shaft 21; and a ring gear 26 having a large diameter connected to a differential case 31 of the differential mechanism 30. Here, the first gear 23 and the second gear 24 mesh with each other, and the third gear 25 and the ring gear 26 mesh with each other.

The differential mechanism 30 functions to absorb a rotational difference between left and right drive wheels at the time of cornering of a vehicle or the like and transmit power to each of the left and right output shafts 22L and 22R and has a publicly-known configuration, and thus, is omitted from detailed description here, but a pair of pinion gears and side gears meshing with the pinion gears are accommodated in the differential case 31. Note that an oil pan P is provided at a bottom portion in the inside of the gear accommodating portion Sg of the housing 2, and a predetermined amount of oil is stored in the oil pan P. Then, a portion (outer peripheral portion) of the ring gear 26 is immersed in the oil stored in the oil pan P.

Further, in the electric power unit 1 according to the present embodiment, an oil pump 40 and an oil cooler 50, which are auxiliary machines, are attached to the housing 2. Here, the oil pump 40 is rotationally driven by a pump motor 41 which is a driving source. Further, a cooling water pipe 51 extending from a radiator (not illustrated) and passing through the inverter accommodating portion Si is connected to the oil cooler 50, and the oil is cooled in the oil cooler 50 by heat exchange with cooling water. Then, cooling water provided to cool oil in the oil cooler 50 is returned from the cooling water pipe 51 to the radiator (not illustrated). In this manner, cooling water continuously circulates in a closed circuit to cool the inverter (not illustrated) and oil accommodated in the inverter accommodating portion Si.

In the electric power unit 1 configured as described above, when DC current is output from a battery (not illustrated), the DC current is converted into AC current by the inverter (not illustrated). When the AC current is supplied to the electric motor 10, the electric motor 10 is rotationally driven by electromagnetic induction action. That is, the rotor 12 and the shaft 11 of the electric motor 10 are rotationally driven at a predetermined speed, and the rotation is decelerated at a predetermined reduction ratio by the speed reduction mechanism 20 and transmitted to the differential mechanism 30. Then, the rotation transmitted to the differential mechanism 30 is distributed to the left and right by the differential mechanism 30 and transmitted to each of the left and right output shafts 22L and 2R, and both the output shafts 22L and 22R rotate at a predetermined speed.

Here, although not illustrated, the left and right output shafts 22L and 22R are connected to left and right axles, respectively, and left and right drive wheels are attached to end portions of the left and right axles, respectively. Therefore, when the left and right output shafts 22L and 22R rotate as described above, the drive wheels (not illustrated) attached to both the axles are rotationally driven, and a vehicle travels at a predetermined speed.

When the electric power unit 1 is driven as described above, the oil pump 40 is driven by the pump motor 41, and cooling water circulates through a closed circuit by a cooling water pump (not illustrated).

Since a portion (outer peripheral portion) of the ring gear 26 is immersed in oil stored in the oil pan P provided at a bottom portion of the gear accommodating portion Sg of the housing 2 as described above, the oil in the oil pan P is scooped up by rotation of the ring gear 26. A part of the scooped oil is supplied to each portion of the electric motor 10 through the shaft 11 as indicated by an arrow in FIG. 1 to be used for lubrication and cooling of each portion. Then, the oil provided for lubrication and cooling of each portion of the electric motor 10 drops into the oil pan P and is collected as indicated by an arrow in FIG. 1.

Further, another part of the oil scraped up by the ring gear 26 is supplied for lubrication and cooling of the speed reduction mechanism 20 and the differential mechanism 30, and then, drops into the oil pan P to be collected. Then, a part of the oil in the oil pan P is sent to the oil cooler 50 by the oil pump 40, and is cooled by heat exchange with cooling water flowing through the cooling water pipe 51 in the oil cooler 50 as indicated by an arrow in FIG. 1. Then, the cooled oil is sent to a tray T arranged in an upper portion of the electric motor 10, and oil overflowing from the tray T drops to the electric motor 10 to be used for lubrication and cooling of each portion of the electric motor 10 as indicated by an arrow in FIG. 1. The oil supplied for lubrication and cooling of each portion of the electric motor 10 in this manner is returned to the oil pan P at an inner bottom portion of the gear accommodating portion Sg to be collected.

### [Specific Configuration of Electric Power Unit]

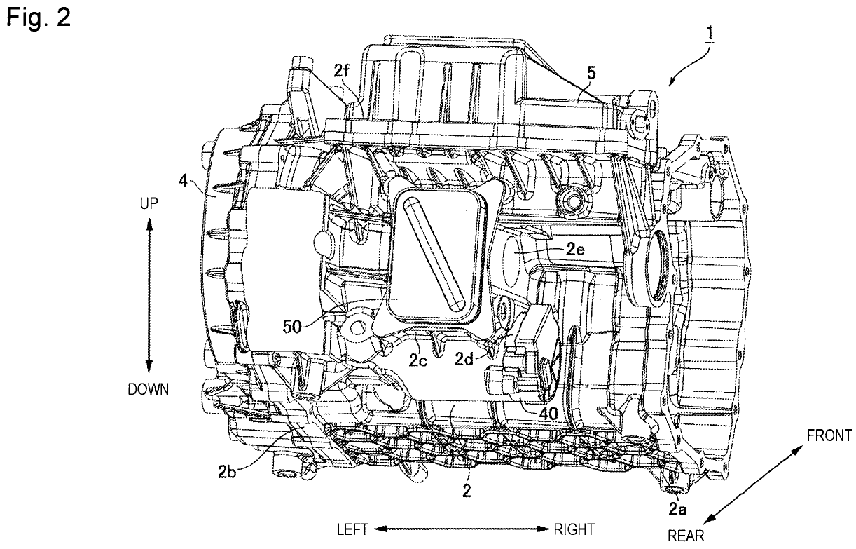

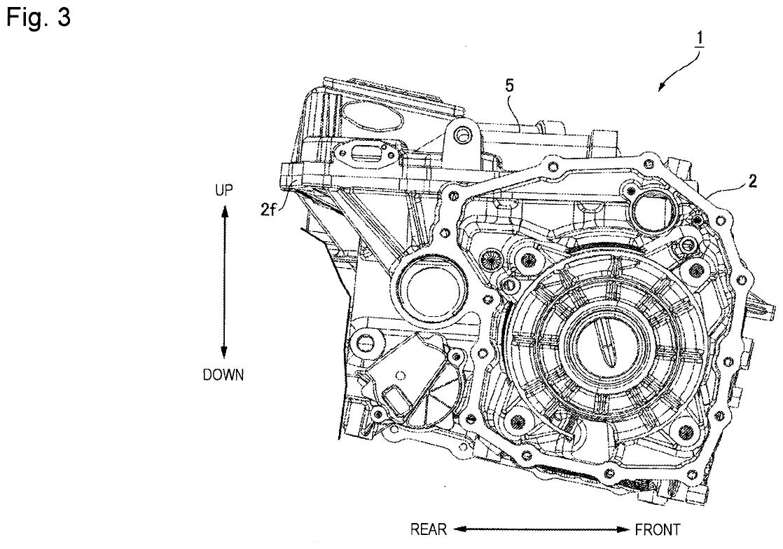

Next, a specific configuration of the electric power unit 1 according to the present invention will be described hereinafter with reference to FIGS. 2 and 3.

FIG. 2 is a perspective view of the electric power unit according to the present invention as viewed from the obliquely right rear side, and FIG. 3 is a right side view of the electric power unit. In FIGS. 2 and 3, arrow directions are “front-rear”, “left-right”, and “up-down” directions, as illustrated.

As illustrated in FIG. 1, the electric motor 10 is accommodated in the right half inside the housing 2 of the electric power unit 1, the speed reduction mechanism 20 and the differential mechanism 30 are accommodated in the left half, and an opening portion (not illustrated) is formed on the left and right of the housing 2. Then, as illustrated in FIG. 2, flange portions 2a and 2b are formed on peripheral edges of left and right opening portions of the housing 2, respectively, a motor cover 3 is detachably attached to the right flange portion 2a by a plurality of bolts (not illustrated), and a gear cover 4 is detachably attached to the left flange portion 2b by a plurality of bolts (not illustrated). That is, the opening portion on the right side of the housing 2 is closed by the motor cover 3, and the opening portion on the left side is closed by the gear cover 4.

Further, as illustrated in FIG. 2, an oil cooler attachment portion 2c having a substantially rectangular block shape is integrally formed at a central portion in the left-right direction (vehicle width direction) of a rear surface of the housing 2, and the oil cooler 50 is attached to the oil cooler attachment portion 2c. Further, a pump attachment portion 2d is integrally formed on the obliquely lower right side of the oil cooler attachment portion 2c on a rear surface of the housing 2, and the oil pump 40 is attached to the pump attachment portion 2d. Note that, as illustrated in FIG. 2, a circular hole 2e through which the left and right output shafts 22L and 22R (see FIG. 1) pass is formed along the left-right direction in the oil cooler attachment portion 2c.

Furthermore, a flange portion 2f is integrally formed on a rear upper surface of the housing 2 as illustrated in FIGS. 2 and 3, and a space surrounded by the flange portion 2f constitutes the inverter accommodating portion Si illustrated in FIG. 1. Then, an inverter (not illustrated) is accommodated in the inverter accommodating portion Si.

An upper surface of the inverter accommodating portion Si (see FIG. 1) is opened, and this upper surface opening portion is closed by an inverter cover 5 detachably attached to the flange portion 2f by a plurality of bolts (not illustrated). Note that the inverter cover 5 is also integrally molded by aluminum die-casting.

### [Inverter Cover]

Next, an embodiment of the inverter cover 5 will be described.

### First Embodiment

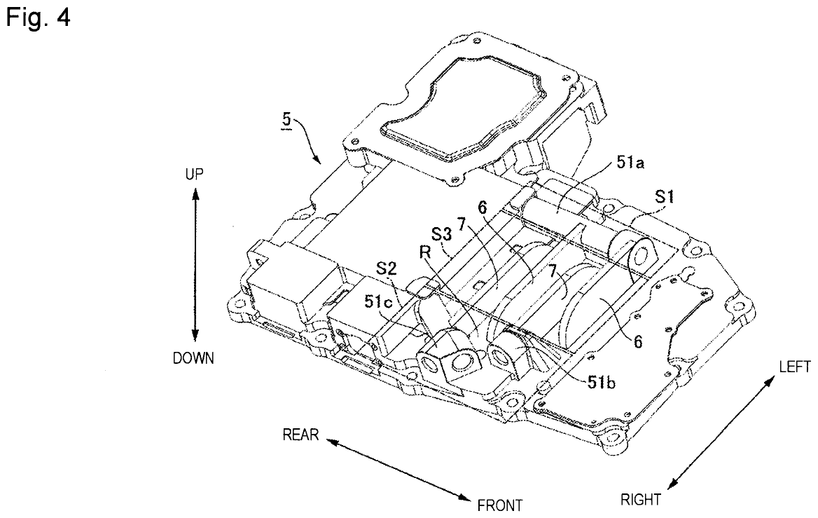

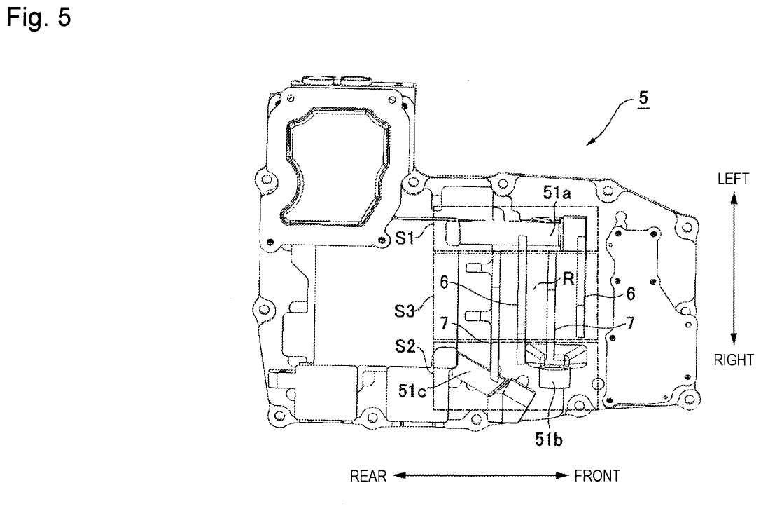

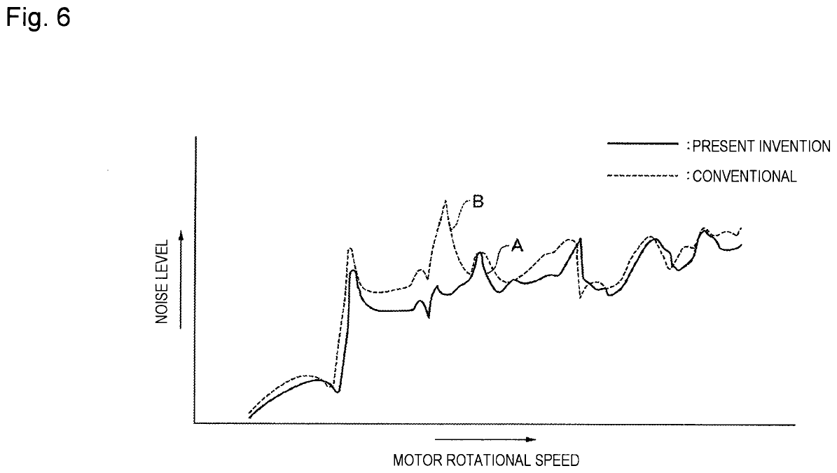

FIG. 4 is a perspective view of the inverter cover according to a first embodiment, FIG. 5 is a plan view of the inverter cover, and FIG. 6 is a diagram illustrating a relationship between a motor rotational speed and a noise level of the electric power unit according to the present invention in comparison with that of a conventional electric power unit.

The inverter cover 5 is a substantially rectangular flat plate-shaped member, and as illustrated in FIGS. 4 and 5, on an upper surface of the inverter cover 5, a first region S1 and a second region S2 in the left-right direction (vehicle width direction) and a third region S3 sandwiched between the first region S1 and the second region S2 are formed. Then, in the first region S1, a pipe portion 51a constituting a part of the cooling pipe 51 (see FIG. 1) is arranged, and the pipe portion 51a constitutes a first connection portion. Further, in the second region S2, pipe portions 51b and 51c constituting a part of the cooling pipe 51 are arranged, and the pipe portions 51b and 51c constitute a second connection portion. Specifically, the pipe portion 51a having a circular pipe shape and extending in a vehicle front-rear direction is integrally provided in a projecting manner in the first region S1 on the left side in the vehicle width direction (upper side in FIG. 5), and two of the pipe portions 51b and 51c similarly having a circular pipe shape are integrally provided in a projecting manner at the front and the rear of the second region S2 on the right side in the vehicle width direction (lower side in FIG. 5).

Furthermore, in the third region S3, four ribs, two first ribs 6 and two second ribs 7, having a plate shape extending in the left-right direction are provided in an erected manner in parallel to each other and at equal intervals alternately along the front-back direction. Here, one axial end (left end) of two of the first ribs 6 is connected to the pipe portion 51a arranged in the first region S1, and another end (right end) of the first rib 6 is a free end and is not connected to the pipe portions 51b and 51c on the right side arranged in the second region S2. Therefore, a predetermined gap is formed between the first rib 6 and the pipe portions 51b and 51c. Note that the first rib 6 and the second rib 7 do not need to be arranged in parallel in a strict sense, and “parallel” here includes substantially parallel.

On the other hand, one axial end (right end) of each of the second ribs 7 is connected to two of the pipe portions 51b and 51c arranged in the second region S2, and another end (left end) of the second ribs 7 is a free end and is not connected to the pipe portion 51a on the left. Therefore, a predetermined gap is formed between the second rib 7 and the pipe portion 51a. As a result, a flow path R having a labyrinth structure is formed on an upper surface of the inverter cover 5 by two each of the first ribs 6 and the second ribs 7 alternately arranged in the front-rear direction, and both end portions of the flow path R are opened to the side.

Here, another axial end portion (end portion on the side not connected to the pipe portion 51a as a first connection portion or two of the pipe portions 51b and 51c as second connection portions) of the first ribs 6 and the second ribs 7 are formed in an arcuate curved surface (R curved surface) shape such that a height gradually decreases toward a tip (free end). A height of two each of the first ribs 6 and the second ribs 7 is set to be equal to or less than a height of the pipe portions 51a, 51b, and 51c. Furthermore, since each of the pipe portions 51a, 51b, and 51c is thicker than two each of the first ribs 6 and the second ribs 7 and has a round pipe shape, rigidity of the pipe portions is set higher than rigidity of each of the first ribs 6 and the second ribs 7.

Note that, in the present embodiment, an end portion on the free end side of each of the first ribs 6 and the second ribs 7 is an arcuate curved surface (R curved surface), and a height of an end portion on the free end side of the first ribs 6 and the second ribs 7 gradually decreases toward a tip (free end). However, an end portion on the free end side of each of the first ribs 6 and the second ribs 7 may be linearly cut, and a height of the end portion may gradually decrease toward a tip (free end).

As described above, in the present embodiment, since two each of the first ribs 6 and the second ribs 7 are alternately arranged in parallel with each other along the front-rear direction on an upper surface of the inverter cover 5, rigidity of the inverter cover 5 is enhanced by the first ribs 6 and the second ribs 7. In particular, in the present embodiment, one longitudinal end (left end) of each of the first ribs 6 is connected to the pipe portion 51a having higher rigidity than the first ribs 6, and one longitudinal end (right end) of each of the second ribs 7 is connected to the pipe portions 51b and 51c having higher rigidity than the second ribs 7, so that rigidity of the inverter cover 5 is effectively enhanced by the first ribs 6 and the second ribs 7.

As described above, since rigidity of the inverter cover 5 is effectively enhanced by four in total of the first ribs 6 and second ribs 7, a noise level accompanying resonance of the inverter cover 5 due to vibration at the time of driving of the electric motor 10 as a vibration source can be reduced to low.

Here, FIG. 6 illustrates a relationship between a motor rotational speed and a noise level of the electric power unit 1 according to the present invention in comparison with that of a conventional electric power unit. A noise level of the electric power unit 1 according to the present invention is reduced to be lower than a conventional noise level, indicated by a broken line B in FIG. 6, in the entire range of a motor rotational speed as indicated by a solid line A in FIG. 6.

Note that, assuming that a circular constant is n, a mass is m, and a spring constant (rigidity) is k, a natural frequency f that generates resonance is obtained by the following formula:

$$f = 1 / 2 Π \cdot {( k / m )}^{1 / 2}$$

and thus, as illustrated in FIG. 6, primary, secondary, and tertiary resonance points and so on (points at which peaks of a noise level appear) shift to a high rotational speed side when rigidity (spring constant k) is increased.

Further, in the present embodiment, as described above, a height of each of the first ribs 6 and each of the second ribs 7 is set to be equal to or less than a height of the pipe portions 51a, 51b, and 51c, and an end portion on the free end side of the first ribs 6 and the second ribs 7 is formed into an arcuate curved surface (R curve) such that a height of the end portion gradually decreases toward a tip. For this reason, rigidity of the inverter cover 5 can be enhanced while increase in a weight of the inverter cover 5 is minimized.

Further, in the inverter cover 5 according to the present embodiment, longitudinal end portions (free ends) of the first rib 6 and the second rib 7 alternately arranged in the front-rear direction are not connected to the pipe portions 51b and 51c or the pipe portion 51a (that is, the pipe portions 51b and 51c for the first rib 6, and the pipe portion 51a for the second rib 7), and a predetermined gap is formed between the longitudinal end portions (free ends) of the first rib 6 and the second rib 7 and the pipe portions 51a, 51b, and 51c. For this reason, the flow path R having a labyrinth structure is formed on an upper surface of the inverter cover 5 by the first rib 6 and the second rib 7, and in a case where water enters an engine room due to precipitation or the like, the water flows along the flow path R by rolling on the left and right sides of a vehicle body during traveling of a vehicle, and is discharged from both end portions (opening portions) of the flow path R to the outside of the inverter cover 5. As a result, water is not accumulated on an upper surface of the inverter cover 5, and occurrence of various troubles associated with accumulation of water is prevented.

### Second Embodiment

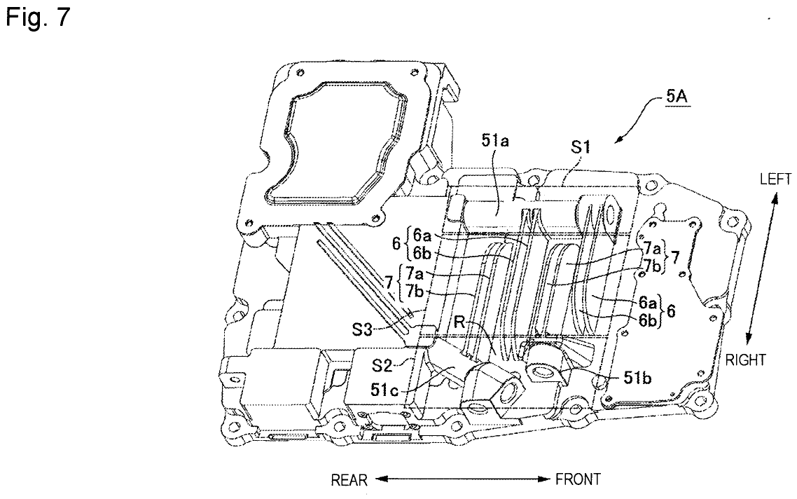

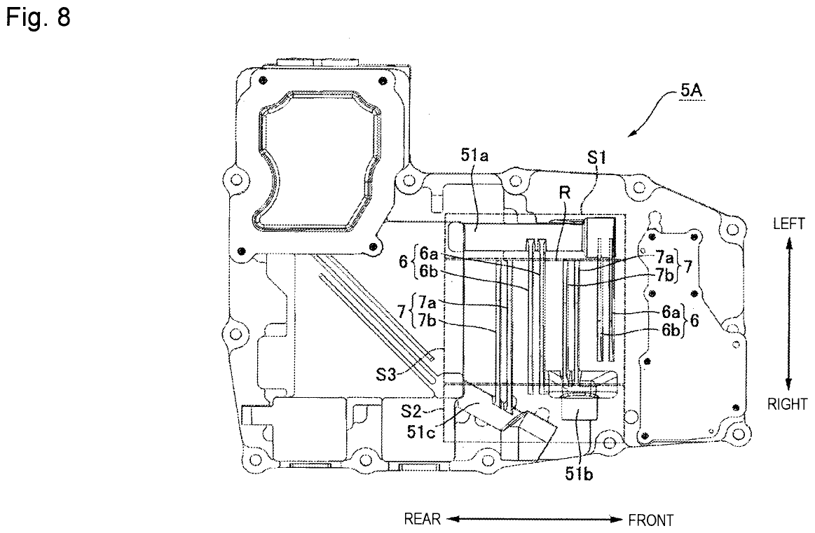

Next, a second embodiment of the inverter cover will be described below with reference to FIGS. 7 and 8.

FIG. 7 is a perspective view of the inverter cover according to the second embodiment, and FIG. 8 is a plan view of the inverter cover. In these views, the same elements as those illustrated in FIGS. 4 and 5 are denoted by the same reference numerals, and hereinafter, description of the elements will be omitted.

In an inverter cover 5A according to the present embodiment, the two first ribs 6 and the two second ribs 7 are constituted by a pair of plates 6a and 6b and a pair of plates 7a and 7b arranged close to each other. By employing such a configuration, rigidity of each of the first ribs 6 and each of the second ribs 7 and rigidity of the inverter cover 5A can be further effectively enhanced, and noise generated from the inverter cover 5A can be effectively reduced.

Note that, although the embodiment in which the present invention is applied to the electric power unit mounted on the electric vehicle (EV) is described above, the present invention is similarly applicable to an electric power unit mounted on a hybrid electric vehicle (HEV), a plug-in hybrid electric vehicle (PHV), or the like.

Further, in the above embodiment, the number of the first ribs and the number of the second ribs formed on the inverter cover are two, and four in total. However, the number of the first ribs and the second ribs formed on the inverter cover is optional, and may be three or more, and six or more in total.

Additionally, the present invention is not limited to the embodiment described above, and various modifications can be made within the scope of the technical idea described in the scope of claims, the description, and the drawings.

1. An electric power unit
accommodating an electric motor in a motor accommodating portion formed in a housing, and accommodating an inverter in an inverter accommodating portion formed in an upper portion of the housing, and
having an upper surface opening portion of the inverter accommodating portion covered with an inverter cover having a flat plate shape,
wherein
a first region, a second region, and a third region sandwiched between the first region and the second region are formed on an upper surface of the inverter cover, and
a first connection portion is arranged in the first region, a second connection portion is arranged in the second region, a plurality of ribs are arranged in parallel in the third region, and a first rib having one longitudinal end portion connected to the first connection portion and a second rib connected to the second connection portion are arranged in a direction in which the first rib and the second rib are arranged in parallel.

2. The electric power unit according to claim 1, wherein the first rib and the second rib are alternately arranged in a direction in which the first rib and the second rib are arranged in parallel.

3. The electric power unit according to claim 1, wherein the first connection portion and the second connection portion have higher rigidity than the first rib and the second rib.

4. The electric power unit according to claim 1, wherein the first connection portion and the second connection portion are thicker than the first rib and the second rib.

5. The electric power unit according to claim 1, wherein a height of another side in a longitudinal direction of the first rib and the second rib gradually decreases toward an end portion.

6. The electric power unit according to claim 1, wherein the first connection portion and the second connection portion are a cooling water pipe integrally provided in a projecting manner on an upper surface of the inverter cover.

7. The electric power unit according to claim 1, wherein the first rib and the second rib include a pair of plates arranged close to each other.
